(19) United States
(12) Patent Application Publication
(10) Pub. No.: US 2021/0385192 A1
(43) Pub. Date: Dec. 9, 2021

(54) ACCESS TO HOME OPERATOR SERVICES WITH SEPARATE WIRELESS NETWORK

(71) Applicant: QUALCOMM Incorporated, San Diego, CA (US)

(72) Inventors: Juan ZHANG, San Diego, CA (US); Ajith Tom PAYYAPPILLY, San Diego, CA (US); Tom CHIN, San Diego, CA (US)

(21) Appl. No.: 17/332,288

(22) Filed: May 27, 2021

Related U.S. Application Data
(60) Provisional application No. 63/036,615, filed on Jun. 9, 2020.

(51) Int. Cl. H04L 29/06; H04W 76/10; H04W 12/06

(52) U.S. Cl. CPC H04L 63/029; H04W 76/10; H04W 84/12; H04L 63/164; H04W 12/06

(57) ABSTRACT

Certain aspects of the present disclosure provide techniques for accessing home operator services with the home subscription using radio access from a subscription on a separate operator. A method that may be performed by a user equipment (UE) includes obtaining a data connection with a first wireless network based on a first subscription, obtaining a tunnel connection with a gateway of a second wireless network through the data connection based on a second subscription associated with the second wireless network, and communicating with the second wireless network through the tunnel connection using the data connection.

### CROSS REFERENCE TO RELATED APPLICATION

This Application hereby claims priority under 35 U.S.C. § 119 to pending U.S. Provisional Patent Application No. 63/036,615, filed on Jun. 9, 2020, the contents of which are incorporated herein in their entirety.

### FIELD OF THE DISCLOSURE

Aspects of the present disclosure relate to wireless communications, and more particularly, to techniques for accessing home operator services with the home subscription using radio access from a subscription on a separate operator.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include communicating with a home network via a tunnel connection over radio access on a second network using a second subscription.

Certain aspects of the subject matter described in this disclosure can be implemented in a method for wireless communications. The method generally includes obtaining a data connection with a first wireless network based on a first subscription, obtaining a tunnel connection with a gateway of a second wireless network through the data connection based on a second subscription associated with the second wireless network, and communicating with the second wireless network through the tunnel connection using the data connection.

Certain aspects of the subject matter described in this disclosure can be implemented in an apparatus for wireless communications. The apparatus generally includes means for obtaining a data connection with a first wireless network based on a first subscription, means for obtaining a tunnel connection with a gateway of a second wireless network through the data connection based on a second subscription associated with the second wireless network, and means for communicating with the second wireless network through the tunnel connection using the data connection.

Certain aspects of the subject matter described in this disclosure can be implemented in an apparatus for wireless communications. The apparatus generally includes an interface configured to obtain a data connection with a first wireless network based on a first subscription and obtain a tunnel connection with a gateway of a second wireless network through the data connection based on a second subscription associated with the second wireless network, and a processing system configured to communicate with the second wireless network through the tunnel connection using the data connection.

Certain aspects of the subject matter described in this disclosure can be implemented in a user equipment (UE). The UE generally includes a receiver configured to receive a data connection with a first wireless network based on a first subscription and receive a tunnel connection with a gateway of a second wireless network through the data connection based on a second subscription associated with the second wireless network, and a processing system configured to communicate with the second wireless network through the tunnel connection using the data connection.

Certain aspects of the subject matter described in this disclosure can be implemented in a computer-readable medium for wireless communications. The computer-readable medium generally includes instructions executable to obtain a data connection with a first wireless network based on a first subscription, obtain a tunnel connection with a gateway of a second wireless network through the data connection based on a second subscription associated with the second wireless network, and communicate with the second wireless network through the tunnel connection using the data connection.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is a block diagram conceptually illustrating a UE with a cellular modem and a wireless local area network (WLAN) modem, in accordance with certain aspects of the present disclosure.

FIG. 4 is a block diagram conceptually illustrating a communication network in which a UE communicates with a core network via a WLAN air interface, in accordance with certain aspects of the present disclosure.

FIG. 5 is a flow diagram illustrating example operations for wireless communication by a UE, in accordance with certain aspects of the present disclosure.

FIG. 6 is a block diagram conceptually illustrating a communication network in which a UE communicates with a home Evolved Packet Core (EPC) via a foreign EPC, in accordance with certain aspects of the present disclosure.

FIG. 7 is a block diagram conceptually illustrating a communication network in which a UE communicates with a home 5G Core Network via a foreign EPC, in accordance with certain aspects of the present disclosure.

FIG. 8 is a signaling flow diagram illustrating example signaling for accessing a home network with a subscription on a separate network, in accordance with aspects of the present disclosure.

FIG. 9 is a flow diagram illustrating example operations for accessing a home network with a subscription on a separate network while considering WLAN availability, in accordance with certain aspects of the present disclosure.

FIG. 10 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for accessing home operator services with a subscription on a separate network. The various apparatus and techniques described herein may allow the user with a multi-SIM device to continue to send and receive regular IMS mobile-originated and mobile-terminated voice calls, using the user's own home phone number, while on a foreign network, without incurring roaming charges. In other words, when accessing a foreign network with an additional SIM, the user is able to get cost-efficient services from the home network using the user's own phone number via the various apparatus and techniques described herein

The following description provides examples of accessing operator services with a separate subscription in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

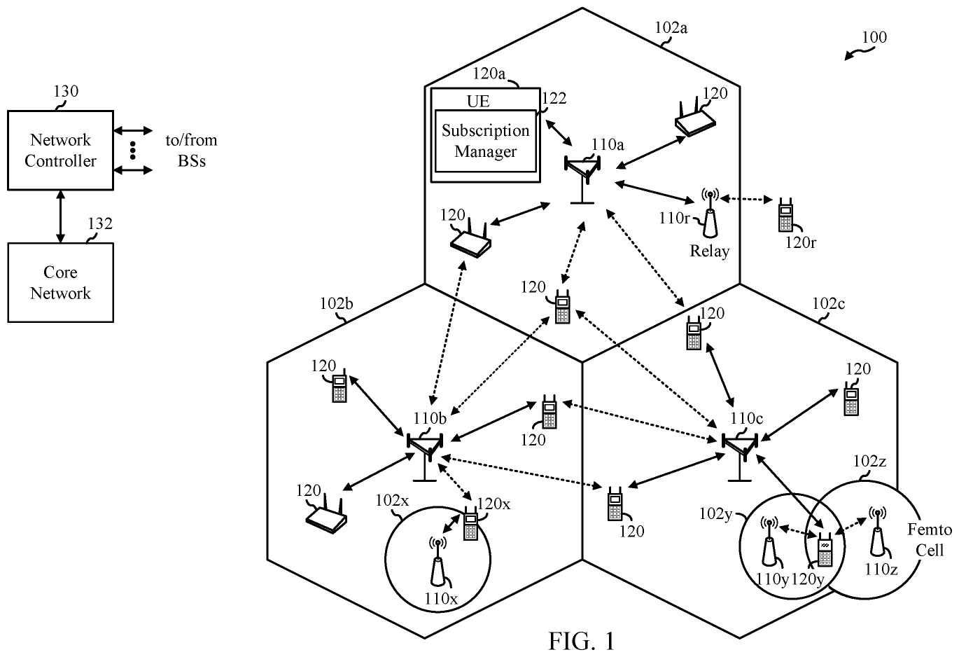

FIG. 1 illustrates an example wireless communication network 100 in which aspects of the present disclosure may be performed. For example, the wireless communication network 100 may be an NR system (e.g., a 5G NR network), an Evolved Universal Terrestrial Radio Access (E-UTRA) system, a Universal Mobile Telecommunications System (UMTS), a CDMA2000 system, or the like. As shown in FIG. 1, the UE 120a includes a subscription manager 122 that provides access to a first wireless network through a data connection on a second wireless network (e.g., the BS 110) based on a second subscription associated with the second wireless network, in accordance with aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

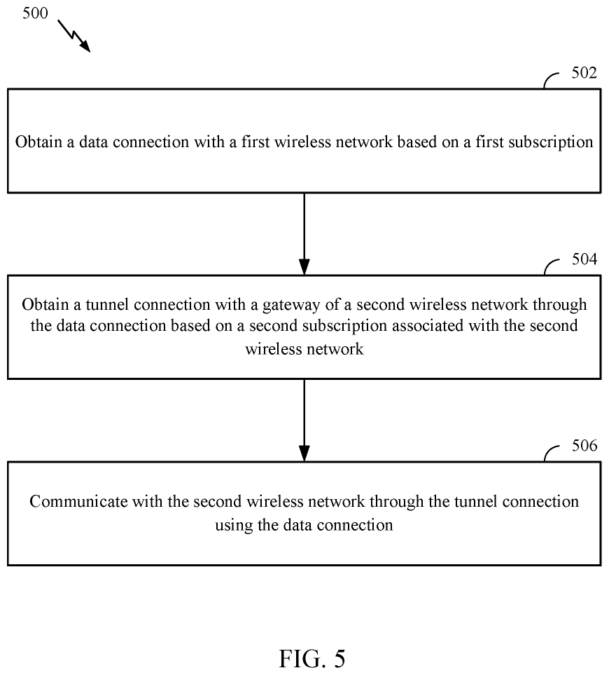

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC) or Evolved Packet Core (EPC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc. In certain aspects, the core network 132 may include a gateway (not shown) that provides access to core network services (e.g., IMS services) over the internet through WLAN interfaces and/or other wireless networks as further described herein with respect to FIGS. 5-9.

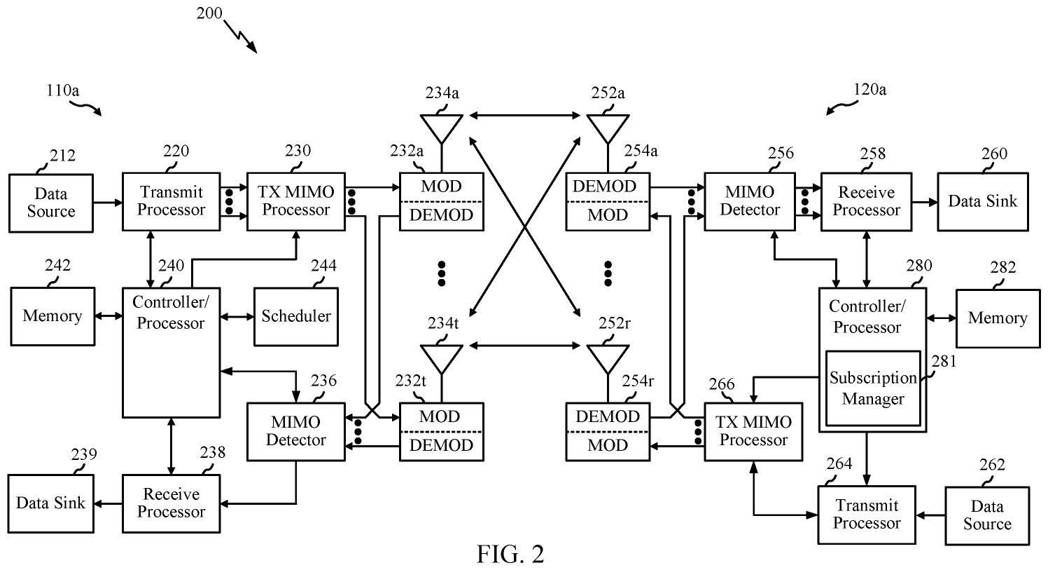

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a has a subscription manager 281 that provides access to a first wireless network through a data connection on a second wireless network (e.g., the BS 110) based on a second subscription associated with the second wireless network, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

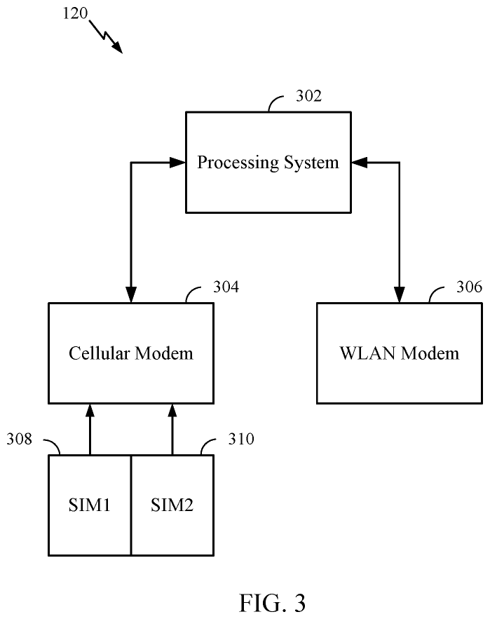

FIG. 3 illustrates a block diagram of an example UE 120. As shown, the UE 120 includes a processing system 302, a cellular modem 304, and a wireless local area network (WLAN) modem 306. The processing system 302 may include a processor coupled to memory, such as the controller/processor 280 coupled to memory 282. The processing system 302 may provide data to the modems 304, 306 for wireless transmissions or obtain data from the modems 304, 306 from wireless receptions. The cellular modem 304 may be configured to communicate with a radio access network (RAN) such as the BSs 110 according to various radio access technologies (RATs), such as 5G NR, E-UTRA, UMTS, CDMA2000, or the like. In aspects, the cellular modem 302 may be coupled to subscriber identity modules (SIMs) 308, 310, which enable the cellular modem 304 to access multiple subscriptions on one or more RANs.

The WLAN modem 306 may be configured to communicate with wireless stations and/or access points in a WLAN, for example, based on the Institute of Electrical and Electronics Engineers (IEEE) 802.11 standards, which denote a set of WLAN air interface standards developed by the IEEE 802.11 committee for short-range communications

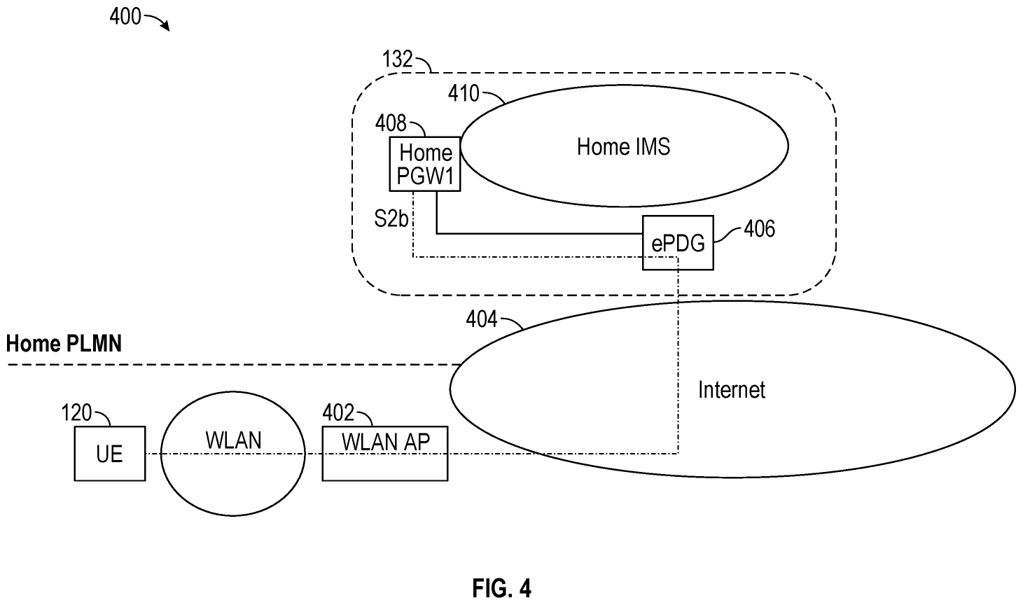

FIG. 4 illustrates a wireless communication network 400 in which a UE 120 communicates with a core network 132 via a WLAN air interface. With access to the UE 120 via the WLAN, the core network 132 is able to provide various services (e.g., voice calls or messaging) to the UE 120 over the WLAN. The UE 120 wirelessly communicates with the access point 402 using a WLAN RAT, such as the IEEE 802.11 standards. For example, the UE 120 may use the WLAN modem 306 to communicate with the access point 402. In certain cases, the UE 120 may obtain a tunnel connection to a gateway 406 of the core network 132 using a data connection through the access point 402. That is, the UE 120 may discover and communicate with the gateway 406 over the internet 404 through the data connection established with the access point 402. The UE 120 may authenticate with the gateway 406 using credentials of a SIM (or subscription) on the wireless network (e.g., a public land mobile network (PLMN)) to which the core network 132 belongs. In aspects, the gateway 406 may provide a connection to a packet gateway 408, which provides a connection to various Internet Protocol-Multimedia Subsystem (IMS) services such as voice calls or messaging. In certain aspects, the gateway 406 may be an evolved packet data network gateway (ePDG) in an EPC or a Non-3GPP Interworking Function (N3IWF) in a 5GC.

### Example Access to Home Operator Services with a Subscription on a Separate Operator

In certain wireless communication networks (such as CDMA2000, UMTS, E-UTRA, and/or 5G NR), a UE may support a plurality of subscriptions (e.g., via a plurality of subscriber identity modules (SIMs) or universal SIMS (USIMs)) with one or more wireless networks. A UE with multiple subscription capabilities (e.g., multiple SIMs) may be able to access various services or functions associated with each of the subscriptions, such as a different subscriber account, a different network (e.g., a RAN), and/or a different radio access technology (RAT) (e.g., E-UTRA or 5G NR). In certain cases, the UE may have a SIM for business use and another SIM for private use, where each SIM provides a separate number and/or data services (e.g., 5G NR and/or E-UTRA data services). In other cases, an additional SIM may be employed when the UE is taken to a different country with a different RAN or RAT. Some multiple subscription configurations enable each subscription to be active simultaneously, allowing communications at any given time (e.g., Dual SIM Single Standby (DSSS), Dual SIM Dual Standby (DSDS), Dual SIM Dual Active (DSDA), Triple SIM Triple Standby (TSTS), etc.).

In certain cases, a user may face steep roaming charges for wireless communication services when visiting a foreign country/network. In order to reduce these roaming charges, some users may have multi-SIM devices, and while in a foreign country, a user may have a local operator's SIM (i.e., a SIM for the visiting country referred to as “the first SIM”) and a home SIM (referred to as “the second SIM”) in the multi-SIM device and only use the first SIM for the duration of the user's stay in the foreign country. In other words, the user may turn off the second SIM and only use the first SIM. There are various issues with multi-SIM devices in such a scenario. Since the first SIM has a different (local) phone number, the user cannot receive mobile-terminated voice calls on the user's home number due to the second SIM being ‘turned off” temporarily. As the user's contacts may only know the user's regular phone number on the second SIM, if the user makes a regular mobile-originated voice call with the first SIM, there is a possibility the contact being called may not pick up the phone because the caller ID may show an unrecognized number (the local number from the first SIM).

The user is faced with various options. First, the user can continue to use the first SIM without the second SIM enabled. Next, the user can turn off mobile data on the second SIM with voice roaming enabled. In such a case, the user does not have to incur data roaming charges, but will incur voice roaming charges. As another option, the user may not use regular Internet Protocol-Multimedia Subsystem (IMS) voice calls, but instead the user may use over-the-top (OTT) services (e.g., internet-based messaging or calling services), which can be accessed using the first SIM.

Aspects of the present disclosure provide apparatus and techniques for accessing home operator services with a subscription on a separate network (e.g., a RAN in another country). For example, the UE may access a gateway (e.g., an evolved packet data network gateway (ePDG) or a Non-3GPP Interworking Function (N3IWF)) of the home network through a data connection on the foreign network using a subscription on the foreign network. In aspects, the UE may communicate with the home network via a tunnel connection (e.g., an Internet Protocol Security (IPsec) tunnel connection) over the data connection on the foreign network using the first subscription. The various apparatus and techniques described herein may allow the user with a multi-SIM device to continue to send and receive regular IMS mobile-originated and mobile-terminated voice calls, using the user's own home phone number, while on a foreign network, without incurring roaming charges. In other words, when accessing a foreign network with an additional SIM, the user is able to get cost-efficient services from home network using the user's own phone number via the various apparatus and techniques described herein.

In aspects, the cellular modem may be spoofed to behave like a WLAN modem to access the home network, for example as described herein with respect to FIG. 4, when the cellular modem is connected over the foreign visited operator's cellular network using the first local SIM. The cellular modem connects to the home operator's ePDG over the internet using the credentials from the second (home) SIM. The home operator effectively thinks the user wants Voice-over-WiFi (VoWiFi) rather than Voice-over-LTE (VoLTE) and sets up the routes for calls accordingly over the internet to and from the ePDG instead of the home or visited cellular networks.

The software implementation of the cellular modem may be configured to access the home network using the first subscription. As further described herein, the quality of WLAN signals versus cellular signals may determine whether the UE accesses the home network over the WLAN or the RAN of the first subscription. The cellular modem may send Internet Key Exchange signaling to the ePDG of the home network to establish a secure tunnel connection (e.g., the IPsec tunnel connection) through which various services may be communicated.

Even though the UE is connected to the internet using the credentials and other info from the first (foreign local) SIM, the UE may take the credentials of the second (normal home) SIM and uses those credentials to establish the tunnel connection to the home ePDG over the data connection to the internet on the foreign network. Various algorithms may manage the case of mobility of the UE, for example, from coverage area of the home network to a coverage area of the foreign network or to WLAN (or vice versa).

Aspects of the present disclosure may be applied to various RATs such as E-UTRA or 5G NR. For example, if the home core network has deployed a 5GC, the core network may use a N3IWF as the gateway to the 5GC rather than an ePDG. The foreign network to which the second SIM provides access may be a 5G system or E-UTRA system, and the home network may be a 5G system or E-UTRA system. For example, the SIM 308 may provide access to a 5G system or E-UTRA system of the home core network, and the SIM 310 may provide access to a 5G system or E-UTRA system of the foreign core network.

FIG. 5 is a flow diagram illustrating example operations 500 for wireless communication, in accordance with certain aspects of the present disclosure. The operations 500 may be performed, for example, by a UE (e.g., the UE 120a in the wireless communication network 100). The operations 500 may be implemented as software components that are executed and run on one or more processors (e.g., controller/processor 280 of FIG. 2). Further, the transmission and reception of signals by the UE in the operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting (providing) signals.

The operations 500 may begin at 502, where the UE may obtain a data connection with a first wireless network (e.g., a first PLMN) based on a first subscription (e.g., the SIM 308). At 504, the UE may obtain a tunnel connection with a gateway of a second wireless network (e.g., a second PLMN) through the data connection based on a second subscription (e.g., the SIM 310) associated with the second wireless network. At 506, the UE may communicate with the second wireless network through the tunnel connection using the data connection.

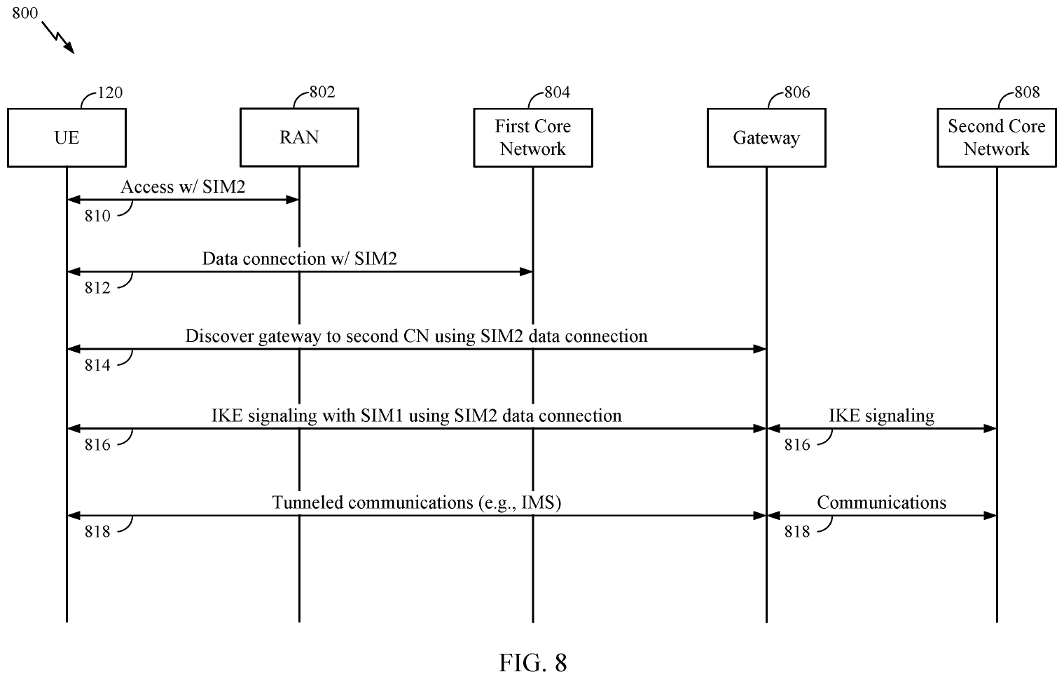

At 502, the UE may obtain the data connection with the first wireless network through radio resource control (RRC) signaling and/or non-access-stratum (NAS) signaling, for example, as further described herein with respect to FIG. 8. For example, the UE may transmit, to the first wireless network, a request to establish an RRC connection (e.g., an RRCConnectionRequest message) and receive, from the first wireless network, an RRC setup message (e.g., an RRCConnectionSetup message) establishing the RRC connection. With the RRC connection, the UE may attach to the core network of the first wireless network. For example, the UE may transmit a request to establish a packet data network (PDN) connection (e.g., a PDN connectivity request message) on a core network of the first wireless network, and the UE may receive a message activating the PDN connection (e.g., an Activate Default Evolved Packet System (EPS) Bearer Context Request message) from the core network of the first wireless network.

At 504, the UE may obtain the tunnel connection by discovering the gateway over the internet with the data connection and establishing the tunnel connection with the core network of the second wireless network, for example, using IKE signaling (e.g., IKEv2 as specified in IETF RFC 5996). The operations 500 may include the UE obtaining a domain name (e.g., a fully qualified domain name (FQDN)) or an address (e.g., a static IP address) of the gateway using the data connection. For example, the UE may send a domain name system (DNS) query for the domain name of the gateway and receive, in response to the query, the domain name of the gateway. The UE may transmit (or provide), to the gateway via the domain name or the address of the gateway, a request to establish the tunnel connection (e.g., an IKE_SA_INIT message).

In aspects, the UE may obtain the tunnel connection at 504 by authenticating with the second wireless network using one or more credentials of the second subscription. In certain aspects, the one or more credentials include at least one of a subscriber identity (e.g., an international mobile subscriber identity (IMSI)) or an authentication key (e.g., keys derived from an Extensible Authentication Protocol (EAP) using the SIM). As an example, the UE may send an authentication request (e.g., IKE_AUTH Request) to the gateway, where the authentication request includes the user identity or subscriber identity (e.g., the IMSI) associated with the subscription. In aspects, the tunnel connection may be an Internet Protocol Security (IPsec) tunnel connection.

At 506, the UE may communicate with the second wireless network via various services (e.g., IMS or non-IMS services). For example, communicating with the second wireless network at 506 may include communicating one or more IMS messages with the second wireless network, where the IMS messages may include at least one of one or more voice packets or one or more multimedia packets.

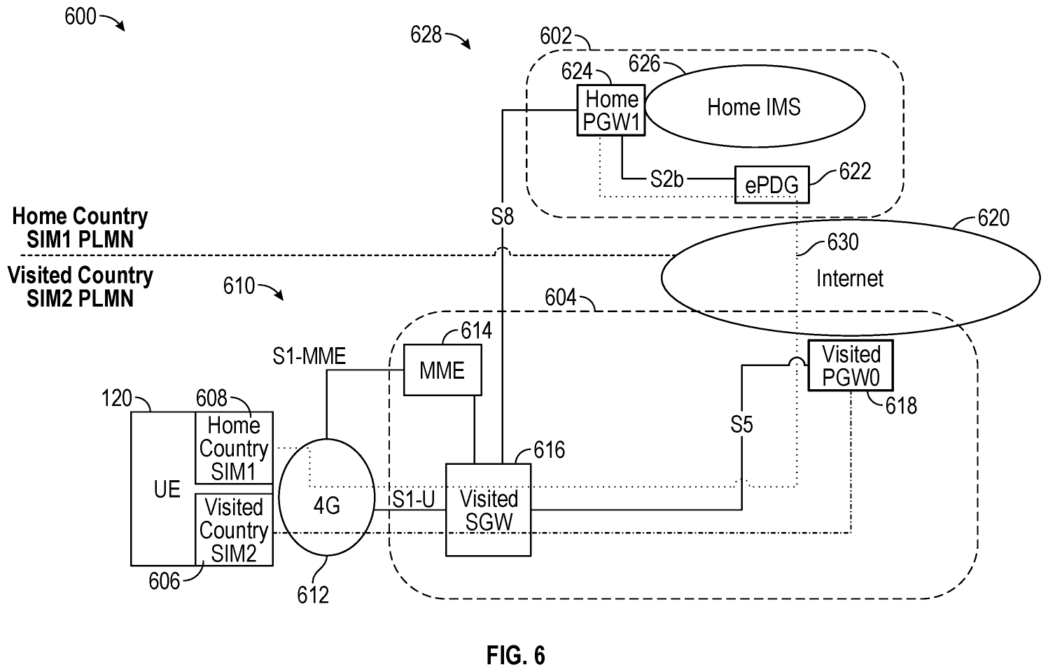

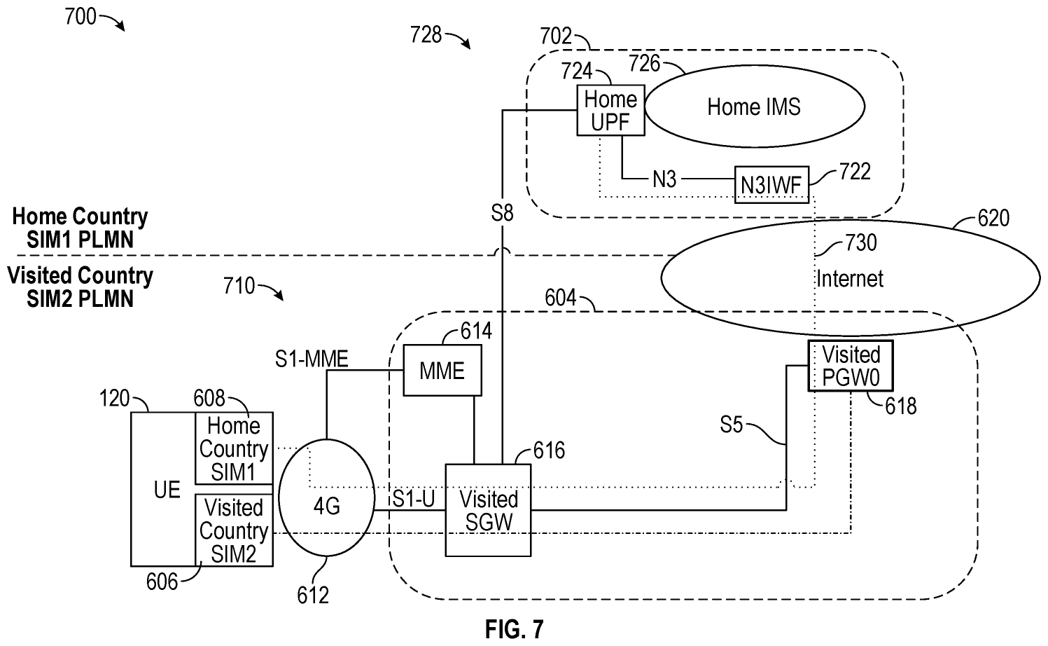

In aspects, the gateway may belong to various core networks such as an EPC or 5GC, for example, as further described herein with respect to FIGS. 6 and 7. That is, the first wireless network may be an E-UTRA system or a 5G NR system, and the second wireless network may be an E-UTRA system or a 5G New Radio system. For example, the gateway may include at least one of an ePDG or an N3IWF, and the gateway may be in communication with a packet gateway (PGU) or a network entity (e.g., server or gateway) having user profile function (UPF).

In aspects, the first and second wireless networks may be associated with separate wireless network operators. For example, the first and second wireless networks may be associated with separate PLMNs belonging to different network operators. In certain cases, the first wireless network may be associated with at least one first PLMN, and the second wireless network may be associated with at least one second PLMN different from the at least one first PLMN. In certain aspects, the first PLMN may be operated by a different wireless network service provider or carrier than the second PLMN. In certain cases, the first PLMN may be visiting country PLMN, and the second PLMN may be the home country PLMN. That is, first and second wireless networks may be associated with separate PLMNs in different countries. For example, the first wireless network may be associated with at least one visiting country public land mobile network (VPLMN), and the second wireless network may be associated with at least one second home country public land mobile network (HPLMN) different from the at least one VPLMN.

In certain aspects, the operations 500 may involve determining whether a WLAN is available for connecting with the gateway of the second wireless network, for example, as described herein with respect to FIG. 4. For instance, if a WLAN is available, the UE may obtain the tunnel connection with the gateway over the WLAN, and if the WLAN is unavailable, the UE may obtain the tunnel connection with the gateway through the data connection with the first wireless network. With respect to the operations 500, the UE may determine that the WLAN is unavailable for connecting with the gateway of the second wireless network, and the UE may obtain the tunnel connection based on the determination that the WLAN is unavailable. In certain aspects, the WLAN may be considered unavailable, if the channel quality of the first wireless network is stronger than the channel quality of the WLAN. In other words, the UE may select the first wireless network over the WLAN depending on the channel quality or channel conditions of the first wireless network compared to the channel quality or channel conditions of the WLAN. More specifically, the channel quality or channel conditions may be determined from a channel quality indicator, a signal-to-noise ratio (SNR), a signal-to-interference plus noise ratio (SINR), a signal-to-noise plus distortion ratio (SNDR), a received signal strength indicator (RSSI), a reference signal received power (RSRP), a reference signal received quality (RSRQ), or the like. In other aspects, the WLAN may be considered unavailable, if the signal strength associated with one or more transmissions from the WLAN is equal to or less than a threshold value. More specifically, such threshold value may be determined by the UE based on previous communications with the WLAN or provided to the UE by the WLAN. In yet other aspects, the WLAN may be overloaded and thus it would inform the UE of such overloading. In other words, the WLAN is unavailable. In other aspects, the WLAN may be considered unavailable, if at least one of the Quality of Expectation (QoE) of delay or throughput is below the user's expectation. In other aspects, the WLAN may be considered unavailable, if UE is restricted to access secured private WLAN.

In certain aspects, the visiting country and home networks may be E-UTRA systems. For example, FIG. 6 illustrates a communication network 600 in which a UE 120 communicates with a home EPC 602 via a foreign EPC 604, in accordance with certain aspects of the present disclosure. As shown, the UE 120 may be a multi-SIM device having a visiting country SIM 606 and a home country SIM 608. The UE 120 may be in the coverage area of a visiting country PLMN (VPLMN) 610, such that the UE 120 wirelessly communicates with a RAN 612 of the VPLMN 610 using the visiting country SIM 606. The RAN 612 may be in communication with the EPC 604 including a mobility management entity (MME) 614, a serving gateway (SGW) 616, and a packet data network gateway (PGW) 618. The MME 614 may control the radio access connection with the UE 120, the SGW 616 may route and forward user data packets across the foreign EPC 604 and to the RAN 612, and the PGW 618 may provide access to various data networks such as the internet 620.

The UE 120 may setup a tunnel connection 630 with the home EPC 602 via a data connection on the foreign EPC 604. For example, the UE 120 may send a request to setup a tunnel connection to the ePDG 622 of the home EPC 602 using the credentials of the home SIM 608. The ePDG 622 may forward authentication requests for the tunnel connection to various network entities (e.g., an Authentication, Authorization, Accounting (AAA) server and/or Home Subscriber Server (HSS) (not shown)) of the home EPC 602 from the UE 120. Once the tunnel connection is established, the ePDG 622 may forward user packets to/from the PGW 624 of the home EPC 602, which may provide access to IMS services 626, for example. In other words, the tunnel connection 630 between the UE 120 and the home EPC 602 may terminate at the ePDG 622, and the ePDG 622 may route user packets from or to the UE 120 across the various network entities of the home EPC 602. Expressed another way, the UE 120 may communicate with the home country PLMN 628 (including the home EPC 602) through the tunnel connection 630 over the visiting country PLMN 610.

In certain aspects, the visiting country network may be an E-UTRA system, and the home country network may be a 5G NR system. For example, FIG. 7 illustrates a communication network 700 in which a UE 120 communicates with a home 5GC 702 via the foreign EPC 604, in accordance with certain aspects of the present disclosure. As shown, the UE 120 may setup a tunnel connection 730 with the home 5GC 702 via a data connection on the foreign EPC 604. The UE 120 may send a request to setup a tunnel connection to the N3IWF 722 of the home EPC 602 using the credentials of the home SIM 608. The N3IWF 722 may forward authentication requests for the tunnel connection to various network entities (e.g., Access and Mobility Management Function (AMF), Authentication Server Function (AUSF), and/or Unified Data Manager (UDM) (not shown)) of the home 5GC 702 from the UE 120. Once the tunnel connection is established, the N3IWF 722 may forward user packets to/from the User Plane Function (UPF) 724 of the home 5GC 702, which may provide access to IMS services 726, for example. In other words, the tunnel connection 730 between the UE 120 and the home 5GC 702 may terminate at the N3IWF 722, and the N3IWF 722 may route user packets from or to the UE 120 across the various network entities of the home 5GC 702. Expressed another way, the UE 120 may communicate with the home country PLMN 728 (including the home 5GC 702) through the tunnel connection 730 over the visiting country PLMN 710.

While the examples depicted in FIGS. 6 and 7 are described herein with respect to an EPC-EPC tunnel connection and EPC-5GC tunnel connection to facilitate understanding, aspects of the present disclosure may also be applied to various RATs, such as the visiting country network being a 5GC and the home country network being a 5GC (5GC-5GC) or the visiting country network being a 5GC and the home country network being a EPC, for example.

FIG. 8 is a signaling flow diagram illustrating example operations 800 for accessing a home network with a subscription on a separate network, in accordance with certain aspects of the present disclosure. As shown, at 810, the UE 120 may establish radio access with a RAN 802 of a first wireless network (e.g., the VPLMN 604) using a subscription (e.g., SIM2) with the first wireless network. For example, the UE may transmit, to the RAN 802, a request to establish an RRC connection (e.g., an RRCConnectionRequest message) and receive, from the RAN 802, an RRC setup message (e.g., an RRCConnectionSetup message) establishing the RRC connection.

At 812, the UE 120 may establish a data connection to a first core network 804 (e.g., an EPC or 5GC) of the first wireless network. For example, the UE 120 may transmit, to the RAN 802, a request to establish a PDN connection (e.g., a PDN connectivity request message) on the first core network 804 of the first wireless network, and the UE may receive a message activating the PDN connection (e.g., an Activate Default Evolved Packet System (EPS) Bearer Context Request message) from the first core network 804 of the first wireless network via the RAN 802.

At 814, the UE 120 may discover a gateway 806 (e.g., an ePDG or N3IWF) of a second wireless network (e.g., the HPLMN 602) using the data connection of the first wireless network. For example, the UE may send a DNS query for the domain name of the gateway 806 and receive, in response to the query, one or more domain names of the gateway 806.

At 816, the UE 120 may establish a tunnel connection to the second core network 808 (e.g., the EPC 602 or 5GC 702) of the second wireless network through the gateway 806 using the data connection of the first wireless network. In certain cases, the tunnel connection may be established with IKE signaling using the credentials of the subscription (e.g., SIM1) on the second wireless network. For example, the UE 120 may send, to the gateway 806 through the data connection on the first wireless network, a request to establish the tunnel connection (e.g., an IKE_SA_INIT message). The UE 120 may also send an authentication request (e.g., IKE_AUTH Request) to the gateway 806, where the authentication request includes the user identity or subscriber identity (e.g., the IMSI) associated with the subscription on the second wireless network (e.g., SIM1). The gateway 806 may forward the IKE signaling to/from the second core network 808 establishing the tunnel connection.

At 818, the UE 120 may communicate with the second core network 808 through the tunnel connection over the data connection with the first core network 804. The gateway 806 may forward user packets of the UE 120 to/from the second network 808. In certain cases, the tunnel connection may provide access to IMS services on the second network 808, such as voice services or messaging services.

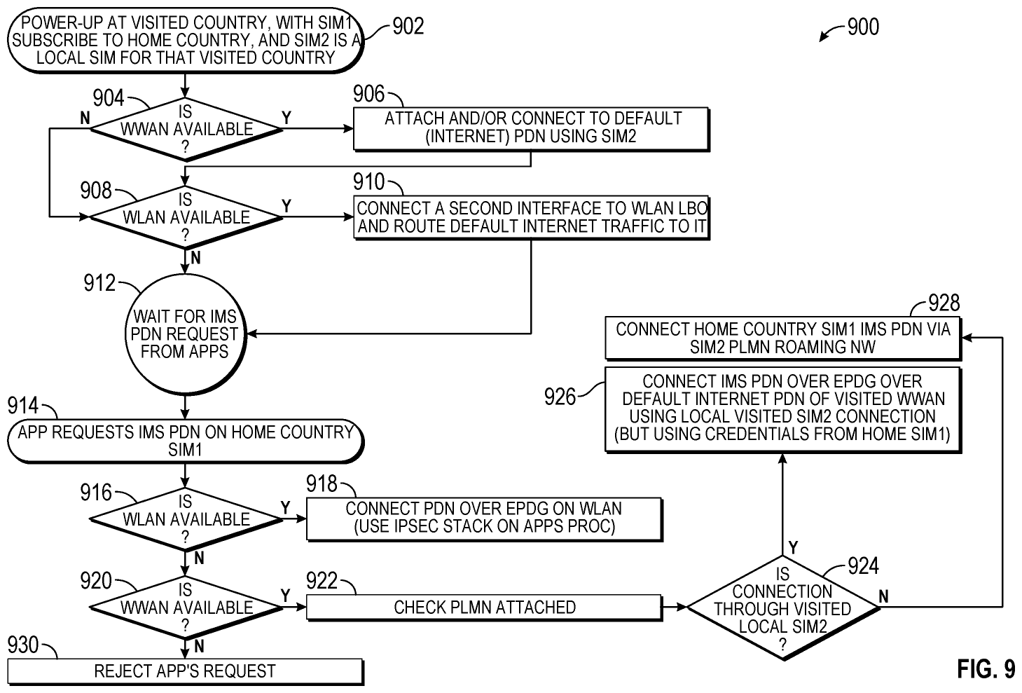

In certain aspects, accessing the home operator services via a second wireless network may depend on whether a WLAN is available. FIG. 9 is a flow diagram illustrating example operations 900 for accessing a home network with a subscription on a separate network while considering WLAN availability, in accordance with certain aspects of the present disclosure. As shown, at 902, a UE may power up in the coverage area of a visiting country PLMN (VPLMN), where the UE is a multi-SIM device having a subscription (SIM2) for the VPLMN and a subscription (SIM1) for a home country PLMN (HPLMN). At 904, the UE may determine whether the wireless wide area network (WWAN) of the VPLMN is available for establishing a data connection. In certain cases, the UE may monitor for reference signals and measure the reference signals to determine whether the WWAN (RAN) is available for the data connection. If the WWAN of the VPLMN is available, the UE may attach and connect to the PDN of the VPLMN using SIM2. At 908, the UE may determine whether the WLAN is available for establishing a data connection. If the WLAN is available, the UE may connect to the WLAN and route internet traffic to the WLAN at 910.

At 912, the UE may wait for IMS PDN request from various applications (e.g., a voice call application or messaging application). At 914, the UE may obtain a request from an application to access IMS PDN services on the HPLMN using SIM1. At 916, the UE may determine whether the WLAN is available for establishing a tunnel connection to the HPLMN. At 918, if the WLAN is available, the UE may connect to the HPLMN over a gateway via the WLAN, for example, as described herein with respect to FIG. 4.

If the WLAN is unavailable, the UE may determine whether the WWAN is available for establishing a tunnel connection to the HPLMN at 920. At 922, if the WWAN is available, the UE may identify the PLMN on which the UE is camped. At 924, the UE may determine whether the UE is connected to the VPLMN using SIM2. If the UE is connected to the VPLMN using SIM2, the UE may establish a tunnel connection to the HPLMN using SIM2 with the credentials of SIM1 at 926, for example, as described herein with respect to FIGS. 5-8. If the UE is roaming on the VPLMN, the UE may establish a tunnel connection to the HPLMN using the roaming data connection on the VPLMN at 928. If the WWAN is unavailable, the UE may reject the request from the application to access IMS services on the HPLMN at 930.

While the various examples are described herein with respect to accessing a home operator service from a foreign country to facilitate understanding, aspects of the present disclosure may also be applied to accessing a second wireless network via a first wireless network, where the first and second wireless networks reside in the same country, but are operated by different wireless service providers.

While the various examples are described herein with respect to accessing IMS services (e.g., voice calls or text messages) to facilitate understanding, aspects of the present disclosure may also be applied to any home operator service (IMS or non-IMS). For example, the various apparatus and techniques described herein for accessing a home network may facilitate access to various home operator services such as short message service (SMS), rich communication service (RCS), video telephony, etc.

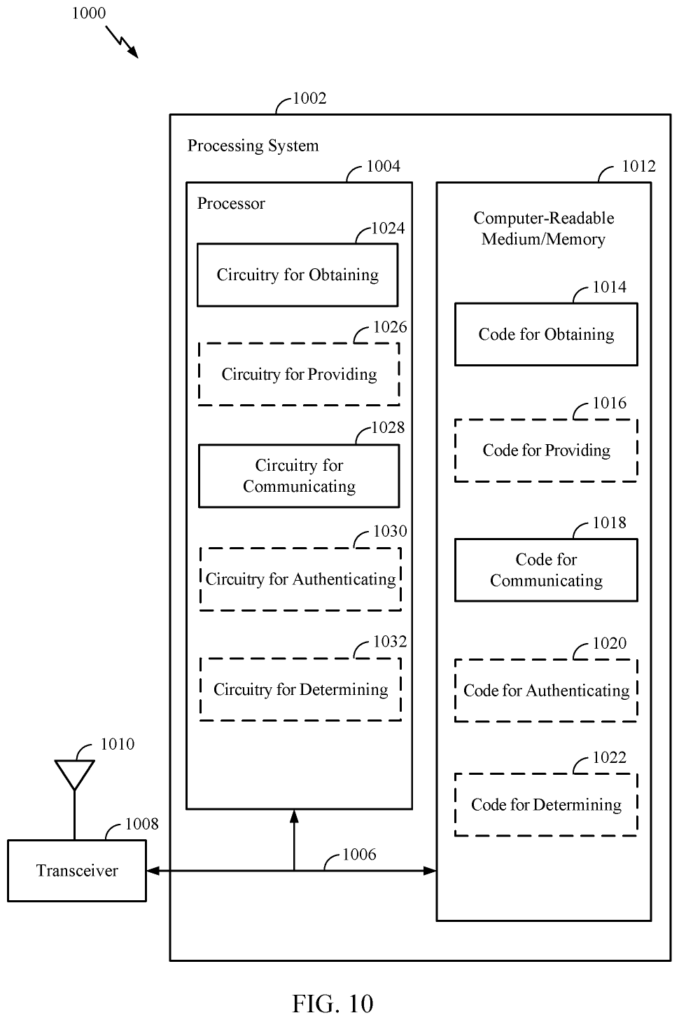

FIG. 10 illustrates a communications device 1000 (e.g., the UE 120) that may include various components (e.g., corresponding to means-plus-function components) configured to perform operations for the techniques disclosed herein, such as the operations illustrated in FIGS. 4, 8, and 9. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIGS. 4, 8, and 9, or other operations for performing the various techniques discussed herein for accessing home operator services with a separate subscription. In certain aspects, computer-readable medium/memory 1012 stores code for obtaining 1014, code for providing 1016, code for communicating 1018 (e.g., code for transmitting and/or code for receiving), code for authenticating 1020, and/or code for determining 1022. In certain aspects, the processor 1004 has circuitry configured to implement the code stored in the computer-readable medium/memory 1012. The processor 1004 includes circuitry for obtaining 1024, circuitry for providing 1026, circuitry for communicating 1028 (e.g., circuitry for transmitting and/or circuitry for receiving), circuitry for authenticating 1030, and/or circuitry for determining 1032.

### Example Aspects

In addition to the various aspects described above, aspects of specific combinations are within the scope of the disclosure, some of which are detailed below:

Aspect 1: A method of wireless communications, comprising: obtaining a data connection with a first wireless network based on a first subscription; obtaining a tunnel connection with a gateway of a second wireless network through the data connection based on a second subscription associated with the second wireless network; and communicating with the second wireless network through the tunnel connection using the data connection.

Aspect 2: The method of Aspect 1, further comprising: obtaining a domain name or an address of the gateway using the data connection; and wherein obtaining the tunnel connection with the gateway comprises providing, to the gateway via the domain name or the address of the gateway, a request to establish the tunnel connection.

Aspect 3: The method of any one of any one of Aspects 1-2, wherein obtaining the tunnel connection comprises authenticating with the second wireless network using one or more credentials of the second subscription.

Aspect 4: The method of Aspect 3, wherein authenticating with the second wireless network comprises authenticating with Internet Key Exchange (IKE) signaling using the one or more credentials.

Aspect 5: The method of any one of Aspects 1-4, wherein the tunnel connection is an Internet Protocol Security (IPsec) tunnel connection.

Aspect 6: The method of any one of Aspects 1-5, wherein communicating with the second wireless network comprises communicating one or more Internet Protocol-Multimedia Subsystem (IMS) messages with the second wireless network.

Aspect 7: The method of Aspect 6, wherein the one or more IMS messages comprise at least one of one or more voice packets or one or more multimedia packets.

Aspect 8: The method of any one of Aspects 1-7, wherein obtaining the tunnel connection comprises obtaining the tunnel connection based on one or more credentials of the second subscription, wherein the one or more credentials include at least one of a subscriber identity or an authentication key.

Aspect 9: The method of any one of Aspects 1-8, wherein the gateway includes at least one of an evolved packet data network gateway (ePDG) or a Non-3GPP Interworking Function (N3IWF).

Aspect 10: The method of any one of Aspects 1-9, wherein the first wireless network is associated with at least one first public land mobile network (PLMN), and the second wireless network is associated with at least one second PLMN different from the at least one first PLMN.

Aspect 11: The method of any one of Aspects 1-10, further comprising: determining that a wireless local area network (WLAN) is unavailable for connecting with the gateway of the second wireless network, wherein obtaining the tunnel connection comprises obtaining the tunnel connection based on the determination that the WLAN is unavailable.

Aspect 12: The method of any one of Aspects 1-11, wherein the first wireless network is associated with at least one visiting country public land mobile network (VPLMN), and the second wireless network is associated with at least one second home country public land mobile network (HPLMN) different from the at least one VPLMN.

Aspect 13: The method of any one of Aspects 1-12, wherein the first wireless network is an Evolved Universal Terrestrial Radio Access (E-UTRA) network or a Fifth Generation (5G) New Radio network, and the second wireless network is an E-UTRA network or a 5G New Radio network.

Aspect 14: An apparatus for wireless communications, comprising at least one antenna and means for performing the operations of one or more of Aspects 1-13.

Aspect 15: An apparatus for wireless communications, comprising an interface and a processing system including at least one processor configured to perform the operations of one or more of Aspects 1-13.

Aspect 16: A user equipment (UE), comprising: a receiver configured to receive a data connection with a first wireless network based on a first subscription and receive a tunnel connection with a gateway of a second wireless network through the data connection based on a second subscription associated with the second wireless network; and a processing system configured to communicate with the second wireless network through the tunnel connection using the data connection.

Aspect 17: A computer-readable medium for wireless communications, comprising instructions executable by an apparatus to perform the operations of one or more of Aspects 1-13.

The techniques described herein may be used for various wireless communications technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node such as a UE or a BS may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, processors 258, 264 and 266, and/or controller/processor 280 of the UE 120a shown in FIG. 2 may be configured to perform operations 500 of FIG. 5.

Means for receiving may include a transceiver, a receiver or at least one antenna and at least one receive processor illustrated in FIG. 2. Means for transmitting, means for sending or means for outputting may include, a transceiver, a transmitter or at least one antenna and at least one transmit processor illustrated in FIG. 2. Means for communicating, means for providing, means for authenticating, means for performing and means for determining may include a processing system, which may include one or more processors, such as processors 258, 264 and 266, and/or controller/processor 280 of the UE 120a and/or processors 220, 230, 238, and/or controller/processor 240 of the BS 110a shown in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 4, FIG. 8, and/or FIG. 9.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method of wireless communications, comprising:
obtaining a data connection with a first wireless network based on a first subscription;
obtaining a tunnel connection with a gateway of a second wireless network through the data connection based on a second subscription associated with the second wireless network; and
communicating with the second wireless network through the tunnel connection using the data connection.

2. The method of claim 1, further comprising:
obtaining a domain name or an address of the gateway using the data connection; and
wherein obtaining the tunnel connection with the gateway comprises providing, to the gateway via the domain name or the address of the gateway, a request to establish the tunnel connection.

3. The method of claim 1, wherein obtaining the tunnel connection comprises authenticating with the second wireless network using one or more credentials of the second subscription.

4. The method of claim 3, wherein authenticating with the second wireless network comprises authenticating with Internet Key Exchange (IKE) signaling using the one or more credentials.

5. The method of claim 1, wherein the tunnel connection is an Internet Protocol Security (IPsec) tunnel connection.

6. The method of claim 1, wherein communicating with the second wireless network comprises communicating one or more Internet Protocol-Multimedia Subsystem (IMS) messages with the second wireless network.

7. The method of claim 6, wherein the one or more IMS messages comprise at least one of one or more voice packets or one or more multimedia packets.

8. The method of claim 1, wherein obtaining the tunnel connection comprises obtaining the tunnel connection based on one or more credentials of the second subscription, wherein the one or more credentials include at least one of a subscriber identity or an authentication key.

9. The method of claim 1, wherein the gateway includes at least one of an evolved packet data network gateway (ePDG) or a Non-3GPP Interworking Function (N3IWF).

10. The method of claim 1, wherein the first wireless network is associated with at least one first public land mobile network (PLMN), and the second wireless network is associated with at least one second PLMN different from the at least one first PLMN.

11. The method of claim 1, further comprising:
determining that a wireless local area network (WLAN) is unavailable for connecting with the gateway of the second wireless network;
wherein obtaining the tunnel connection comprises obtaining the tunnel connection based on the determination that the WLAN is unavailable.

12. The method of claim 1, wherein the first wireless network is associated with at least one visiting country public land mobile network (VPLMN), and the second wireless network is associated with at least one second home country public land mobile network (HPLMN) different from the at least one VPLMN.

13. The method of claim 1, wherein the first wireless network is an Evolved Universal Terrestrial Radio Access (E-UTRA) network or a Fifth Generation (5G) New Radio network, and the second wireless network is an E-UTRA network or a 5G New Radio network.

14. An apparatus of wireless communications, comprising:
an interface configured to:
obtain a data connection with a first wireless network based on a first subscription; and
obtain a tunnel connection with a gateway of a second wireless network through the data connection based on a second subscription associated with the second wireless network; and
a processing system configured to communicate with the second wireless network through the tunnel connection using the data connection.

15. The apparatus of claim 14, wherein:
the interface is further configured to obtain a domain name or an address of the gateway using the data connection; and
the interface obtains the tunnel connection with the gateway by providing, to the gateway via the domain name or the address of the gateway, a request to establish the tunnel connection.

16. The apparatus of claim 14, wherein the interface obtains the tunnel connection by authenticating with the second wireless network using one or more credentials of the second subscription.

17. The apparatus of claim 16, wherein the interface authenticates with the second wireless network by authenticating with Internet Key Exchange (IKE) signaling using the one or more credentials.

18. The apparatus of claim 14, wherein the tunnel connection is an Internet Protocol Security (IPsec) tunnel connection.

19. The apparatus of claim 14, wherein the processing system communicates with the second wireless network by communicating one or more Internet Protocol-Multimedia Subsystem (IMS) messages with the second wireless network.

20. The apparatus of claim 19, wherein the one or more IMS messages comprise at least one of one or more voice packets or one or more multimedia packets.

21. The apparatus of claim 14, wherein the interface obtains the tunnel connection by obtaining the tunnel connection based on one or more credentials of the second subscription, wherein the one or more credentials include at least one of a subscriber identity or an authentication key.

22. The apparatus of claim 14, wherein the gateway includes at least one of an evolved packet data network gateway (ePDG) or a Non-3GPP Interworking Function (N3IWF).

23. The apparatus of claim 14, wherein the first wireless network is associated with at least one first public land mobile network (PLMN), and the second wireless network is associated with at least one second PLMN different from the at least one first PLMN.

24. The apparatus of claim 14, wherein:
the processing system is further configured to determine that a wireless local area network (WLAN) is unavailable for connecting with the gateway of the second wireless network;
the interface obtains the tunnel connection by obtaining the tunnel connection based on the determination that the WLAN is unavailable.

25. The apparatus of claim 14, wherein the first wireless network is associated with at least one visiting country public land mobile network (VPLMN), and the second wireless network is associated with at least one second home country public land mobile network (HPLMN) different from the at least one VPLMN.

26. The apparatus of claim 14, wherein the first wireless network is an Evolved Universal Terrestrial Radio Access (E-UTRA) network or a Fifth Generation (5G) New Radio network, and the second wireless network is an E-UTRA network or a 5G New Radio network.

27. A user equipment (UE), comprising:
a receiver configured to:
receive a data connection with a first wireless network based on a first subscription; and
receive a tunnel connection with a gateway of a second wireless network through the data connection based on a second subscription associated with the second wireless network; and
a processing system configured to communicate with the second wireless network through the tunnel connection using the data connection.

28. The UE of claim 27, wherein:
the receiver is further configured to receive a domain name or an address of the gateway using the data connection; and
the receiver receives the tunnel connection by providing, to the gateway via the domain name or the address of the gateway, a request to establish the tunnel connection.

29. The UE of claim 27, wherein the receiver receives the tunnel connection by authenticating with the second wireless network using one or more credentials of the second subscription.

30. The UE of claim 27, wherein:
the processing system is further configured to determine that a wireless local area network (WLAN) is unavailable for connecting with the gateway of the second wireless network;
the receiver receives the tunnel connection by obtaining the tunnel connection based on the determination that the WLAN is unavailable.
